(19) United States
(12) Patent Application Publication
(10) Pub. No.: US 2007/0029401 A1
(43) Pub. Date: Feb. 8, 2007

(54) LAN-based sprinkler system

(76) Inventor: Hooshang Kaen, La Jolla, CA (US)

Correspondence Address: ROGITZ & ASSOCIATES, 750 B STREET, SUITE 3120, SAN DIEGO, CA, 92101, US

(21) Appl. No.: 11/187,304

(22) Filed: Jul. 22, 2005

(51) Int. Cl. A01G 27/00

(52) U.S. Cl. 239/69; 239/201; 239/550; 239/565; 239/207; 239/266

(57) ABSTRACT

An irrigation system has a master controller and a single backbone pipe with a single isolation valve controlled by the master controller. Branch lines can tap into the backbone pipe and a solenoid valve installed in each branch line, with each branch line leading to plural sprinkler heads. Each solenoid valve is controlled by a respective group controller, and the master controller controls each group controller by addressing “open” and “shut” messages to the group controllers over two and only two wires that run alongside the backbone pipe.

### FIELD OF THE INVENTION

The present invention relates generally to computer-controlled irrigation systems.

### BACKGROUND OF THE INVENTION

Most current automatic sprinkler systems are designed to irrigate lawns and gardens based primarily on a so-called “star” configuration, in which each and every pipe which carries water must be connected to a central manifold of computer-actuated valves that are electrically connected to a control unit. The control unit can turn each valve on and off by, e.g., energizing or deenergizing a solenoid associated with the valve for a programmable period of time. Therefore, each valve which is connected to a pipe can support a given area. The designated area is serviced by the pipe which in turn supports a number of sprinkler heads.

As recognized herein, such a “star” configuration by its very structure is equipped with a fundamental limitation on the number of valves that it can control given a physical limitation on the total number of wires that can efficiently connect to each controller, and the limited capacity of a single manifold to hold more than a handful of valves. Further, star configuration systems will usually only turn one valve on or off at a time. Moreover, these systems do not come equipped with a master control valve to prevent expensive water leakage in the event of a pipe or sprinkler head rupture.

### SUMMARY OF THE INVENTION

The present system employs common local area network (LAN) techniques which facilitate the use of one and only one pipe running into the area which requires irrigation. At any location, one simply taps a branch line into the common pipe and connects it through a valve to the sprinkler heads. The valves are controlled by respective group controllers, which in turn are connected via two and only two wires to a system controller. The pair of wires runs alongside the main water pipe and is common to all the group controllers.

Accordingly, an irrigation system includes a master controller, one and only one backbone pipe, and a main isolation valve in the backbone pipe and controlled by the master controller. Plural branch lines are tapped into the backbone pipe, with each branch line leading to at least one sprinkler head. A respective branch line isolation valve is installed in each branch line, and a respective group controller is electrically connected to each branch line isolation valve. The master controller controls each group controller by addressing “open” and “shut” messages to the group controller over two and only two wires that run alongside the backbone pipe. Each group controller is electrically connected to the two and only two wires.

In non-limiting implementations, electrical power from a power source can be sent along the wires to power the group controllers (and solenoids of branch line isolation valves). Also, if desired a pressure sensor can be in fluid communication with the backbone pipe and can be electrically connected to the master controller. The master controller may open the main isolation valve, shut the branch line isolation valves by means of appropriate commands to the group controllers, and determine whether a leak exists in the backbone pipe based on the signal from the pressure sensor. Then, the master controller can shut all of the branch line isolation valves except for a first branch line isolation valve, with the controller determining whether a leak exists in the branch line associated with the first branch line isolation valve based on the signal from the pressure sensor. Succeeding branch lines can be tested for leaks in the same way.

In other non-limiting embodiments a reservoir holding a substance can be connected to the backbone pipe by a reservoir pipe, and a reservoir isolation valve can be installed in the reservoir pipe and controlled by the master controller to establish fluid communication between the reservoir and at least a first branch line to thereby cause the substance in the reservoir to be delivered through the sprinkler heads associated with the first branch line.

In another aspect, a local area network (LAN) for an irrigation system includes a master controller and plural group controllers each associated with its own address and each selectively energizing a respective solenoid of a respective area isolation valve in response to commands addressed to it from the master controller.

In still another aspect, an irrigation system includes plural groups of sprinklers arranged in areas, and a respective area isolation valve is associated with each group of sprinklers. The system also includes group logic means associated with each area isolation valve for opening and shutting the valve. Each group logic means is associated with a unique address. Master logic means communicate with each group logic means over a network means, with the master logic means sending commands to each group logic means. A command that is intended for one and only one group logic means contains the unique address of the group logic means.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of the present irrigation system; and

FIG. 2 is a flow chart of non-limiting logic that can be employed by the present system.

### DETAILED DESCRIPTION OF THE PREFERRED EMBODIMENT

The present irrigation system distributes control of irrigation valves over a local area network (LAN) such that no central manifold is needed. At any point on the lawn or other area to be irrigated, one simply taps into a backbone pipe and connects a branch line isolation valve with its own group controller to the backbone pipe. A group controller may be a logic device that can include a processor chip or logic circuitry, and a group controller and its associated branch line isolation valve may be housed together as a single module. Only two wires need be in the LAN system, with all control elements being connected to the same common wires. A master controller can address each individual group controller by its own unique identification or other address.

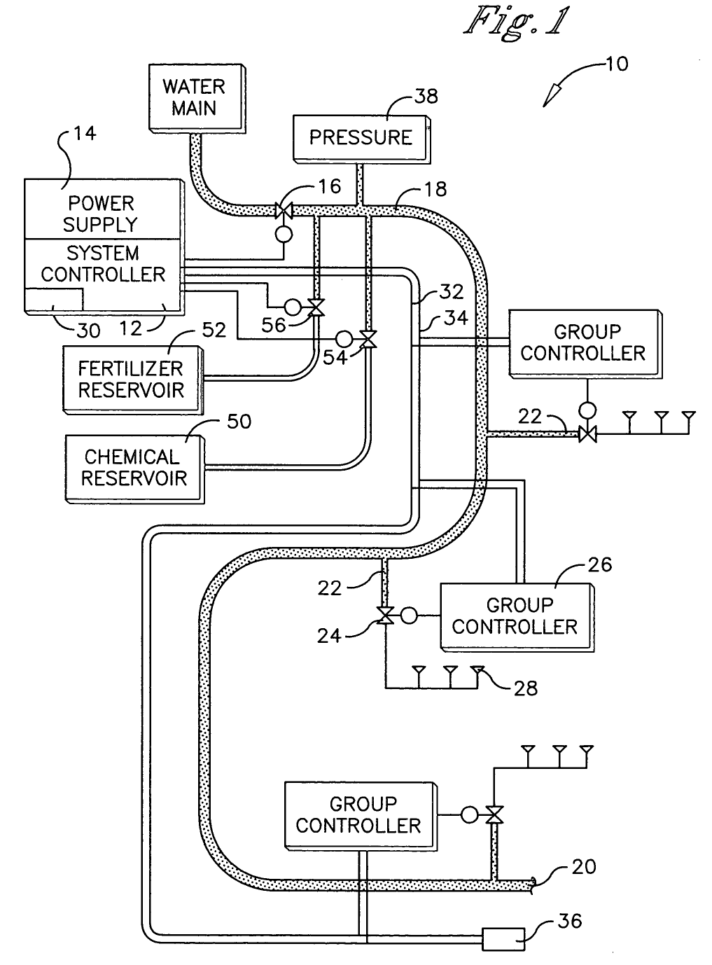

With greater specificity and now referring to FIG. 1, a system is shown, generally designated 10, which includes a system or master controller 12 and a power supply 14. The master controller 12 may be any suitable logic device such as a digital processor that may be embodied on a chip or logic circuitry that functions in accordance with principles herein. The power supply 14 may be a suitable power supply such as a battery, or a transformer/rectifier connected to the AC grid, or the AC grid itself for systems that do not require transformation and rectification.

A main isolation valve 16 is disposed in a backbone pipe 18 of the system 10 as shown. The backbone pipe 18 is connected to the water main, and in one non-limiting embodiment the main isolation valve 16 is a solenoid-controlled valve, the solenoid of which is electrically connected to the master controller 12. The backbone pipe 18 may be formed in any suitable configuration to extend through an area to be irrigated, with the backbone pipe 18 not establishing a circuit but rather dead-ending at an end 20.

As shown in FIG. 1, plural branch lines 22 may be tapped into the backbone pipe 18. A respective branch line isolation valve 24 may be installed in each branch line 22, preferably close to the backbone pipe 18, and each branch line isolation valve 24 may be a solenoid valve or other valve suitable for control by a controller. Accordingly, each branch line isolation valve 24 is electrically connected to a respective group controller 26, which may be separate from or housed integrally with the solenoid of the associated isolation valve. Each group controller 26 may be any suitable logic device such as a digital processor that may be embodied on a chip or logic circuitry that functions in accordance with principles herein. In any case, one or more sprinkler heads 28 can be in fluid communication with each branch line 22 downstream of the respective branch line isolation valve 24 as shown.

In accordance with the present invention, the master controller 12 issues commands to the group controllers 26 over a LAN to individually or collectively open and shut the associated branch line isolation valves 24 in accordance with whatever irrigation program a user might program into the master controller 12 by means of a suitable input device 30, such as a keypad.

One implementation of the LAN includes two and only two common wires 32, 34, which preferably run from the master controller 12 along the length of the backbone pipe 18, e.g., within a few inches of the backbone pipe 18, and which advantageously can be placed in the same trench as the backbone pipe 18 during installation of the backbone pipe. Each group controller 26 is electrically connected to the two LAN lines 32, 34 as shown, with each group controller 26 having its own unique address or ID and, hence, with each group controller 26 being able to recognize commands from the master controller 12 and present on the line or lines 32, 34 that are addressed to it. Thus, in addition to the benefit of fewer pipes and excavation afforded by use of a single backbone pipe 18, the implementation of the system 10 shown in FIG. 1 provides a relatively simple electrical physical connection, i.e., only one pair of wires 32, 34 is needed to control tens or hundreds of valves. The wires 32, 34 may terminate at a junction box 36. Less optimally, a wireless LAN can be used.

Accordingly, it may now be appreciated that each group controller 26 can be addressed and selected through a command signal sent from the master controller 12, which command signal is sent to each and every group controller but only acted upon by the group controller (or controllers) whose address is (or whose addresses are) indicated in the command signal. In response to commands from the master controller 12 that are addressed to it, a group controller 26 opens and shuts its respective branch line isolation valve 24.

It is to be understood that the master controller 12 can be capable of addressing one group controller 26 at a time, and it may also be capable of issuing commands to plural group controllers by addressing a command to more than one group controller address. In this way, the master controller 12 can send a “paging” notification to all the group controllers to, e.g., open all branch line isolation valves 24 for a function such as flushing, cleaning, fertilizing or other uses.

Additionally, in non-limiting implementations of the system 10 power line communications (PLC) principles are used in the network, wherein power from the power supply 14 is transmitted through the lines 32, 34 in addition to command signals from the master controller 12, further reducing the need for more than only two wires.

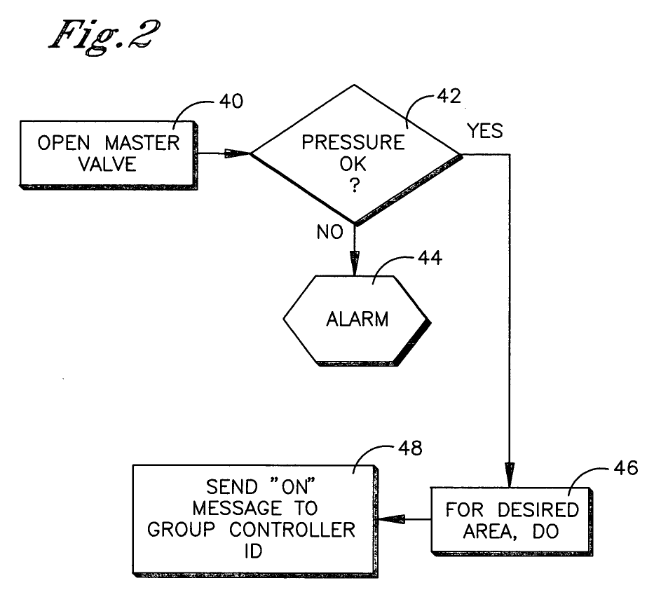

In non-limiting implementations, recognizing the need to conserve water, the system 10 may be provided with a pressure sensor 38. Because only a single backbone pipe 18 need be provided, only a single pressure sensor which communicates with the backbone pipe need be provided. It is to be understood that the pressure sensor 38 communicates with the master controller 12. In any case, referring briefly to the logic diagram of FIG. 2, using the signal from the pressure sensor 38 the master controller can determine whether a leak exists and if so, where.

More specifically, commencing at block 40, the main isolation valve 16 is opened, and initially the master controller 12 can command the group controllers 26 to shut their respective branch line isolation valves. Then, at decision diamond 42 it is determined whether pressure is satisfactory. For instance, a pressure signal from the sensor 38 that indicates that pressure in the backbone pipe 18 is below an expected threshold could indicate that a leak exists in the backbone line. In this case, an alarm can be generated at state 44 to alert the user of a leak.

This pressure check can be repeated for each branch line 22 once the backbone pipe 18 has been satisfactorily tested by opening the main isolation valve 16 and by commanding each group controller in succession to open its branch line isolation valve, with the other group controllers being commanded to maintain their valves shut. Of course, some pressure drop will be expected due to water exiting the sprinklers, but an unexpectedly large pressure drop indicates a leak in the affected branch line. After leak testing, the logic can proceed to block 46 to enter the programmed irrigation scheme, wherein an “on” signal is sent to each group controller 26, by address, at the appropriate time by the master controller 12 at block 48.

Returning to FIG. 1, in some implementations the system 10 may include a chemical reservoir 50 and/or a fertilizer reservoir 52. A respective reservoir isolation valve 54, 56 can be installed in pipes that connect each reservoir 50, 52 to the backbone pipe 18 as shown. Like the other valves discussed thus far, the reservoir isolation valves may be solenoid-controlled valves and are controlled by the master controller 12 as shown. In this way, chemicals and/or fertilizers may be injected into the system on an area by area basis by opening the appropriate reservoir isolation valve and branch line isolation valves associated with the areas sought to be treated. Many different tanks holding chemicals and fertilizers tailored to the whole yard or to a specific type of plant can be added to the system and be controlled by the master controller 12 for use on selected areas.

While the particular LAN-BASED SPRINKLER SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. An irrigation system, comprising:
at least one master controller;
one and only one backbone pipe;
a main isolation valve in the backbone pipe and controlled by the master controller;
plural branch lines tapped into the backbone pipe, each branch line leading to at least one sprinkler head;
a respective branch line isolation valve installed in each branch line;
a respective group controller electrically connected to each branch line isolation valve, the master controller sending at least one control message to all controllers but addressed to at least one specific group controller such that only the specific group controller acts on the message, the message being sent over wires that run alongside the backbone pipe, each group controller being electrically connected to the wires and each group controller having its own address and executing only those commands from the master controller that contain the address of the group controller.

2. The system of claim 1, further comprising a power source, electrical power from the power source being sent along the wires to power the group controllers.

3. The system of claim 1, comprising a pressure sensor in fluid communication with the backbone pipe and electrically connected to the master controller.

4. The system of claim 3, wherein the master controller opens the main isolation valve, shuts the branch line isolation valves by means of appropriate command signals to the group controllers, and determines whether a leak exists in the backbone pipe based on the signal from the pressure sensor.

5. The system of claim 3, wherein the master controller opens the main isolation valve and shuts all of the branch line isolation valves except for a first branch line isolation valve by means of appropriate command signals to the group controllers, the controller determining whether a leak exists in the branch line associated with the first branch line isolation valve based on the signal from the pressure sensor.

6. The system of claim 1, comprising at least one reservoir holding a substance, the reservoir being connected to the backbone pipe by a reservoir pipe, a reservoir isolation valve being installed in the reservoir pipe and controlled by the master controller to establish fluid communication between the reservoir and at least a first branch line when main isolation valve is open and the branch line isolation valve associated with the first branch line is open in response to an open message from the master controller to the group controller associated with the first branch line to thereby cause the substance to be delivered through the sprinkler heads associated with the first branch line.

7. A local area network (LAN) for an irrigation system, comprising:
at least one master controller; and
plural group controllers each associated with its own address and each selectively energizing a respective solenoid of a respective area isolation valve in response to commands addressed to it from the master controller.

8. The LAN of claim 7, wherein all group controllers communicate with the master controller over wires that are common to all controllers.

9. The LAN of claim 7, further comprising:
one and only one backbone pipe;
a main isolation valve in the backbone pipe and controlled by the master controller;
plural area lines tapped into the backbone pipe, each area line leading to at least one sprinkler head; and
a respective area isolation valve installed in each area line, wherein two and only two run alongside the backbone pipe with each group controller being electrically connected to the two and only two wires.

10. The LAN of claim 9, further comprising a power source, electrical power from the power source being sent along the wires to power the group controllers.

11. The LAN of claim 9, comprising a pressure sensor in fluid communication with the backbone pipe and electrically connected to the master controller.

12. The LAN of claim 11, wherein the master controller opens the main isolation valve, shuts the area isolation valves by means of appropriate command signals to the group controllers, and determines whether a leak exists in the backbone pipe based on the signal from the pressure sensor.

13. The LAN of claim 11, wherein the master controller opens the main isolation valve and shuts all of the area isolation valves except for a first area isolation valve by means of appropriate command signals to the group controllers, the controller determining whether a leak exists in the area line associated with the first area isolation valve based on the signal from the pressure sensor.

14. The LAN of claim 9, comprising at least one reservoir holding a substance, the reservoir being connected to the backbone pipe by a reservoir pipe, a reservoir isolation valve being installed in the reservoir pipe and controlled by the master controller to establish fluid communication between the reservoir and at least a first area line when main isolation valve is open and the area line isolation valve associated with the first area line is open in response to an open message from the master controller to the group controller associated with the first area line to thereby cause the substance to be delivered through the sprinkler heads associated with the first area line.

15. An irrigation system comprising:
plural groups of sprinklers arranged in areas;
a respective area isolation valve associated with each group of sprinklers;
group logic means associated with each area isolation valve for opening and shutting the valve, each group logic means being associated with a unique address; and
master logic means communicating with each group logic means over a network means, the master logic means for sending commands to each group logic means, a command intended for one and only one group logic means containing the unique address of the group logic means.

16. The system of claim 15, wherein the master logic means is a master controller and each group logic means is a group controller, wherein all group controllers communicate with the master controller over wires that are common to all controllers.

17. The system of claim 16, further comprising:
one and only one backbone pipe;
a main isolation valve in the backbone pipe and controlled by the master controller;
plural area lines tapped into the backbone pipe, each area line leading to at least one sprinkler head, wherein a respective area isolation valve is installed in each area line.

18. The system of claim 17, further comprising a power source, electrical power from the power source being sent along the wires to power the group controllers.

19. The system of claim 18, comprising a pressure sensor in fluid communication with the backbone pipe and electrically connected to the master controller.

20. The system of claim 19, wherein the master controller executes at least one of:
(a) opening the main isolation valve, shutting the area isolation valves by means of appropriate command signals to the group controllers, and determining whether a leak exists in the backbone pipe based on the signal from the pressure sensor;
(b) opening the main isolation valve and shutting all of the area isolation valves except for a first area isolation valve by means of appropriate command signals to the group controllers, the controller determining whether a leak exists in the area line associated with the first area isolation valve based on the signal from the pressure sensor.
